(19) United States
(12) Patent Application Publication
(10) Pub. No.: US 2026/0099632 A1
(43) Pub. Date: Apr. 9, 2026

(54) HARDWARE SIGNATURE ANALYSIS TOOL

(71) Applicant: QUALCOMM Incorporated, San Diego, CA (US)

(72) Inventors: Jai KUMAR, San Diego, CA (US); Shankar RADHAKRISHNAN, San Diego, CA (US); Brian PHILLIPS, San Diego, CA (US); Ann Christine IRVINE, Eagle Point, OR (US)

(21) Appl. No.: 18/911,093

(22) Filed: Oct. 9, 2024

(51) Int. Cl. G06F 21/73; G06F 21/75

(52) U.S. Cl. CPC G06F 21/73; G06F 21/75

(57) ABSTRACT

Systems and techniques are provided for circuit analysis. For instance, a process can include obtaining a first representation of a portion of a first circuit; detecting one or more anchor markers in the first representation of the portion of the first circuit; and identifying, based on the detected one or more anchor markers, a first hardware signature, wherein the first hardware signature is based on an arrangement of hardware elements of the first circuit for performing a task.

### FIELD

This application is related to hardware testing tools. For example, aspects of the application relate to a hardware signature tool that may be used to test and/or validate logic circuits, such as a system on a chip (SoC).

### BACKGROUND

After a new logic circuit (e.g., chip, microchip, SoC, processor, etc.) is designed by a chip designer, the logic circuit may be manufactured. Manufacturing a logic circuit can be an expensive and specialized industrial process that some chip designers may not want to undertake. In such cases, the chip designers may outsource logic circuit manufacturing to third party foundries. In some cases, the third-party foundries may adjust aspects of the logic circuit, for example, to accommodate the chip manufacturing process being used. After the logic circuits are manufactured, the logic circuits may be sent back to the chip designers for testing and/or verification before the logic circuits are made purchasable. In some cases, the third-party foundries can be a bit of black box as they may make alterations to a logic circuit. Generally, these changes should not alter the operation of the logic circuit, but as logic circuits become more complex, it can be very difficult to detect, for example vulnerabilities and/or inadvertent changes that may be introduced to a logic circuit design due to changes made to the logic circuit by a third-party foundry. Thus, techniques and/or tools for hardware signature analysis may be useful.

### SUMMARY

Systems and techniques are described herein for hardware signature analysis. For example, an apparatus for circuit analysis is provided. The apparatus includes a memory system comprising instructions and a processor system coupled to the memory system, wherein the processor system is configured to: obtain a first representation of a portion of a first circuit; detect one or more anchor markers in the first representation of the portion of the first circuit; and identify, based on the detected one or more anchor markers, a first hardware signature, wherein the first hardware signature is based on an arrangement of hardware elements of the first circuit for performing a task.

As another example, a method for circuit analysis is provided. The method includes: obtaining a first representation of a portion of a first circuit; detecting one or more anchor markers in the first representation of the portion of the first circuit; and identifying, based on the detected one or more anchor markers, a first hardware signature, wherein the first hardware signature is based on an arrangement of hardware elements of the first circuit for performing a task.

In another example, a non-transitory computer-readable medium having stored thereon instructions is provided. The instructions, when executed by a processor system, cause the processor system to: obtain a first representation of a portion of a first circuit; detect one or more anchor markers in the first representation of the portion of the first circuit; and identify, based on the detected one or more anchor markers, a first hardware signature, wherein the first hardware signature is based on an arrangement of hardware elements of the first circuit for performing a task.

As another example, an apparatus for circuit analysis is provided. The apparatus includes: means for obtaining a first representation of a portion of a first circuit; means for detecting one or more anchor markers in the first representation of the portion of the first circuit; and means for identifying, based on the detected one or more anchor markers, a first hardware signature, wherein the first hardware signature is based on an arrangement of hardware elements of the first circuit for performing a task.

In some aspects, one or more of the apparatuses described herein can include or be part of an extended reality device (e.g., a virtual reality (VR) device, an augmented reality (AR) device, or a mixed reality (MR) device), a mobile device (e.g., a mobile telephone or other mobile device), a wearable device (e.g., a network-connected watch or other wearable device), a personal computer, a laptop computer, a server computer, a television, a video game console, or other device. In some aspects, the one or more apparatuses can include at least one camera for capturing one or more images or video frames. For example, the one or more apparatuses can include a camera (e.g., an RGB camera) or multiple cameras for capturing one or more images and/or one or more videos including video frames. In some aspects, the one or more apparatuses can include a display for displaying one or more images, videos, notifications, or other displayable data. In some aspects, the one or more apparatuses can include at least one transmitter configured to transmit data or information over a transmission medium to at least one device. In some aspects, at least one processor of the one or more apparatuses can include a central processing unit (CPU), a digital signal processor (DSP), a graphics processing unit (GPU), a neural processing unit (NPU), a neural signal process (NSP), or other processing device or component.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and examples, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a flow diagram illustrating different phases for manufacturing a logic circuit, in accordance with aspects of the present disclosure.

FIG. 2 is a flow diagram illustrating a technique for hardware signature analysis, in accordance with aspects of the present disclosure.

FIG. 3 illustrates a technique for training a machine learning model to recognize hardware signatures, in accordance with aspects of the present disclosure.

FIG. 4 is a flow diagram illustrating a process for circuit analysis, in accordance with aspects of the present disclosure.

FIG. 5 is a diagram illustrating an illustrative example of a neural network (e.g., a deep-learning neural network, in accordance with some examples.

FIG. 6 is a diagram illustrating an illustrative example of a convolutional neural network (CNN), in accordance with some examples.

FIG. 7 is a diagram illustrating an example of a system for implementing certain aspects of the present technology.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of subject matter of the application. However, it will be apparent that various examples may be practiced without these specific details. The figures and description are not intended to be restrictive.

The ensuing description provides illustrative examples only, and is not intended to limit the scope, applicability, or configuration of the disclosure. Rather, the ensuing description will provide those skilled in the art with an enabling description for implementing the illustrative examples. It should be understood that various changes may be made in the function and arrangement of elements without departing from the spirit and scope of the application as set forth in the appended claims.

In some cases, logic circuits may be manufactured by third-party foundries. Third-party foundries may have proprietary processes and/or adjustments that may be confidential. However, chip designers also have an interest in the security, integrity, and confidentiality of their designs and may want to ensure that any changes made during the foundry fabrication process does not accidently or otherwise introduce issues in the logic circuit. Therefore, techniques to enhance the test/validation checks for the logic circuit may be useful.

Systems, apparatuses, processes (also referred to as methods), and computer-readable media (collectively referred to as “systems and techniques”) are described herein for hardware signature analysis tool. For example, in some cases, a first representation of a circuit may be obtained by the tool. For example, the first representation may be a graphical design system (GDS) view of the first circuit. In other examples, the first representation may be an image, for example, of a de-layered logic circuit. In some cases, the first representation may be received from a third-party foundry, for example, after the foundry has adjusted a GDS submitted by a chip designer.

The tool may detect one or more anchor markers in the first representation. In some cases, the anchor markers may be detected using machine learning (ML) based feature extractors. Based on the one or more detected anchor markers, the tool may identify a first hardware signature in the first representation. For example, the tool may recognize patterns of anchor markers as corresponding to a particular hardware signature. In some cases, a hardware signature may be a particular arrangement of hardware components of the logic circuit for performing a certain task. In some cases, the tool may obtain a second representation of a second circuit. For example, the tool may obtain a GDS view of the logic circuit as submitted by the chip designed to the foundry. The tool may locate a second hardware signature in the second circuit and verify that the first hardware signature corresponds with the second hardware signature.

In some cases, the tool may identify the first hardware signature using a ML model. The ML model may be trained based on hardware signatures and structure patterns of a netlist (also referred to as netlist structure patterns) that were generated based on a register transfer level design of the logic circuit. In some cases, the netlist may be a detailed description of an electronic circuit, listing the components (e.g., gates, flip-flops, etc.) and interconnections of the components, and the netlist may act as a blueprint for a physical layout of the circuit. The netlist structure patterns may be patterns (e.g., arrangements) in the components and/or interconnections of the netlist. The ML model may be trained to correlate anchor markers with hardware signatures and netlist structure patterns.

Various aspects of the techniques described herein will be discussed below with respect to the figures.

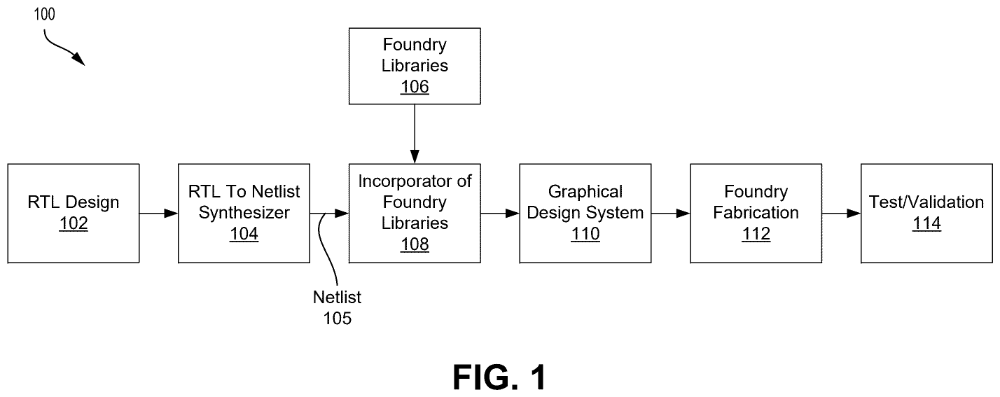

FIG. 1 is a flow diagram illustrating different phases for manufacturing a logic circuit 100. In some cases, a completed logic circuit, by a chip designer, may be in the form of a register transfer level (RTL) design 102. The RTL design 102 may be a design abstraction used for digital circuit design which describes a synchronous digital circuit in terms of the flow of digital signals (e.g., data) between hardware registers. The RTL design 102 describes the logical operations performed by the digital signals. In some cases, the RTL design 102 may describe logical operations in a way similar to low-level computer languages. In some cases, the RTL design 102 may include multiple different design elements, or circuit blocks. These circuit blocks may perform one or more logical tasks, such as certain processing operations, hardware controllers, cryptography engines, key generators, etc. The circuit blocks may be modularly designed and may be reusable across different logic circuit designs.

The RTL design 102 may be synthesized by an RTL to netlist synthesizer 104 to generate a netlist 105 that describes the hardware used to implement the RTL design 102. For example, to synthesize the RTL design to the netlist 105, the RTL to netlist synthesizer 104 may map RTL elements to logic gates and/or cells to implement the logical operations that may be recorded in the netlist 105.

In some cases, after a third-party foundry and manufacturing process (e.g., technology node, process node, etc.), which are selected to manufacture the logic circuit described by the RTL design 102, foundry libraries 106 may be obtained from the foundry for the specific manufacturing process to be used to manufacture the logic circuit. For example, different manufacturing processes may have different transistor sizes and different design rules. The foundry libraries 106 may define the design rules for logic gates and/or cells using the manufacturing process. The netlist 105 may be incorporated with the foundry libraries 106 by incorporator 108 to generate a graphical design system (GDS) 110. For example, a netlist tool may use the foundry libraries 106 to format and/or adjust entries of the netlist 105 and the netlist 105 may be converted to a GDS 110 using a GDS application/tool.

The GDS 110 may be a representation of planer geometric shapes, labels, and other information that may be used to reconstruct photomasks and/or layout artwork for layers of the logic circuit that may be etched into silicon. In some cases, the GDS 110 may be a binary, hierarchical database file format and the GDS 110 may represent the structure of components of the logic circuit. After the GDS 110 for the logic circuit is complete (e.g., tape out), the GDS 110 may be sent to the foundry for fabrication 112. Fabrication 112 by the foundry may include one or more steps for adjusting the logic circuit, such as optical process correction, which may post process the GDS 110 to make the design easier to manufacture by the foundry. Other steps for fabrication 112 may include lithography, etching doping, packaging, etc. In some cases, the fabrication 112 process may be a bit of a black box to the chip designer.

After fabrication 112 is performed, a sampling of the manufactured logic circuits may be shipped to the chip designer. The chip designer may perform testing and/or validation checks 114 on the manufactured logic circuit to ensure the logic circuit performs as expected. In some cases, issues that may be found during the testing/validation checks 114 may be addressed via engineering change orders (ECOs). An ECO may be a design change, or patch, to the original GDS 110 that may be made to avoid completely re-implementing the design, which includes logic synthesis, technology mapping, place, route, layout extraction, timing verification, etc. The ECOs may be integrated by the foundry for additional logic circuit samples for further testing/validation checks 114, or for mass production of the logic circuit.

As indicated above, the foundry fabrication 112 process may be a bit of a black box for chip designers as the foundry may have proprietary processes and/or adjustments that may be confidential. However, chip designers also have an interest in the security, integrity, and confidentiality of their designs and may want to ensure that any changes made during the foundry fabrication 112 process does not accidently or otherwise introduce issues in the logic circuit.

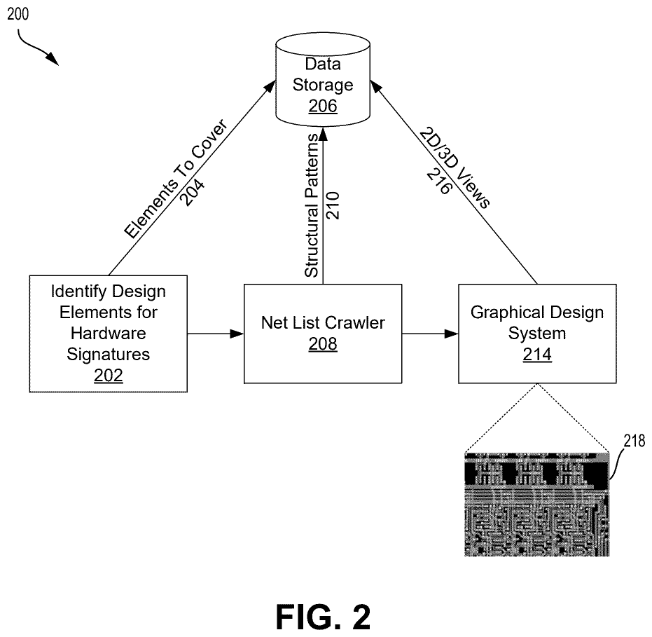

FIG. 2 is a flow diagram illustrating a technique for hardware signature analysis 200, in accordance with aspects of the present disclosure. In some cases, hardware signatures may be generated for portions of a logic circuit by a hardware signature analysis tool. A hardware signature may be an arrangement of hardware elements of a logic circuit to perform a task. In some cases, the portions of the logic circuit may be elements that the chip designer wants to assure are validated as matching the design as submitted to the foundry.

In some cases, identifying 202 which design elements (e.g., elements of the RTL design) to use for matching or aligning with a hardware signature may be performed based on a netlist crawler tool. In some cases, the netlist crawler tool may be trained to have an understanding of the design of the logic circuit (e.g., to match components of the logic circuit to a signature based on a netlist), what the logic circuit is expected to do, what inputs may exercise the elements that are intended to be covered, and what outputs to expect based on those inputs. For example, a particular portion of the logic circuit (e.g., elements) may be identified to be protected by a hardware signature. The netlist crawler tool may then identify inputs that may cause those particular portions to be used (e.g., exercised, input into those elements such that output is generated by the elements). In some cases, the elements to be covered may include logic cones that exercise structures of confidential and/or proprietary logic. A logic cone may be the digital logic components that are used to process a particular input to generate a particular output.

In some cases, elements to be covered by the hardware signature may be selected from the RTL design (e.g., RTL design 102 of FIG. 1) and the logic patterns in the RTL design may act as references for the hardware signature analysis tool. The selected elements to cover may be stored 204 in a database or other memory 206.

After the netlist (e.g., netlist 105 of FIG. 1) is generated, a netlist crawler 208 of the hardware signature analysis tool may be used to extract structural patterns associated with the elements to be covered by the hardware signature from the netlist. For example, if the elements to be covered were selected from the RTL design, the logic cones used to invoke and receive output from those logic cones may be traced through the RTL design and corresponded with a structural pattern of components in the netlist that may be used to implement a logic cone. The structural pattern may include inputs provided, the logic ports and/or nets that the inputs were received on, and the outputs are provided on, levels of logic, register logic used, fan-in and fan-out cones used, combinatorial logic patterns associated with the signature, outputs obtained based on the inputs, and so forth. The fan-in may refer to input signals that may be input, for example, to a logic gate. The fan-in of the logic gate may be based on the design and the specific logic function the logic gate performs. The fan-out may refer to a maximum number of input signals that an output, for example, of a logic gate can drive without degrading the logic gate's performance. The fan-out may be influenced by the output current capabilities of the gate and the input requirements of connected electronic devices. The fan-in cone may refer to a collection of all logic gates and signals that feed into a particular logic gate or node. The fan-in cone may represent the entire network of inputs that influences the state of that logic gate. The fan-out cone may refer to a collection of all logic gates and signals that are driven by the output of a particular logic gate or node. The fan-out cone may represent the entire network of outputs that are influenced by the state of that logic gate. The structural patterns may also include ordering information indicating where in the structural pattern the components are in. The structural patterns from the netlist for the hardware signatures may be stored 210 in the database or memory 206. The structural patterns may be associated with the elements to cover. The combinatorial logic pattern may refer to the specific arrangement and interaction of logic gates in a combinational circuit, where the output is determined solely by the current inputs. The combinatorial logic pattern may be characterized in that they are memoryless so that the output of the combinatorial logic pattern depends only on the presented input and not any previous states and a relationship between inputs and outputs can be described using Boolean expressions, Boolean algebra, and/or truth tables. Combinatorial logic patterns may be used in various circuits including arithmetic circuits (e.g., adders, subtractors, multipliers, etc.), data transmission circuits (e.g., encoders, decoders, multiplexers, demultiplexers, etc.), code converters (e.g., binary to gray code, BCD to 7-segment display, etc.), and/or other types of circuits.

The hardware signature analysis tool may then correspond the structural patterns extracted from the netlist to an arrangement of structural components (e.g., hardware elements) of the GDS 214 (e.g., GDS 110 of FIG. 1) using a mapping tool. For example, the GDS 214 may include sets of shapes (e.g., rectilinear shapes) corresponding to hardware elements of the logic circuit and the hardware signatural analysis tool may include a mapper which maps the structural patterns from the netlist to the corresponding hardware elements and how the hardware elements are laid out and/or ordered. In some cases, the mapper may generate 2D/3D views 218 of the hardware elements that implement the hardware signatures from the GDS 214. In some cases, the mapper may extract hardware elements such as multiple metal layers, vias (e.g., electrical connection between two or more metal layers of a printed circuit boards (PCB)), jogs, library cells, logic cones, width and height of the logic and interconnects, and the like to generate the 2D/3D views 218.

In some cases, the mapper may also add X, Y guides and/or anchor points from the physical design indicating, for example, where a hardware element may be located in the logic circuit. The 2D/3D views 218 of the hardware elements may also be stored 216 in the database or other memory 206. The example 2D/3D view 218 illustrates a particular hardware signature. In some cases, the 2D/3D view 218 may have a clear shape and a distinctive pattern, making them suited for image recognition. For example, the pattern/shape for one set of selected elements may be different from one particular manufacturing process to another. Different hardware signatures may have a different shape/pattern of hardware elements that may be recognized. Recognizing these hardware signatures may be useful, for example, to detect any potential incursions on the hardware signatures during the fabrication process, to verify that expected hardware signatures are present, if an ECO was properly incorporated.

In some cases, the database or other memory 206 may be a private, secure storage use for storing information related to the hardware signature analysis tool. The database or other memory 206 may associate the 2D/3D views 218 with the corresponding selected elements and structural pattern as a particular hardware signature. The X, Y guides, anchor points, or other coordinates and structures, along with markup on patterns may also be added to the database or other memory 206 to help ease detection. In some cases, the markup on patterns may be textual or graphical annotations added to a design to provide additional information and/or instructions. Example markups may include textual notes explaining specific design choices or highlighting areas of concern, markers or labels to identify specific components and/or regions, or highlight areas or features, such as design rule violations, potential issues, areas that may need further review or approval, geometric shapes to represent additional structures or to highlight areas, such as rectangles/polygons to outline regions of interest or additional layers, circles/ellipses to highlight areas, additional layers to represents different types of information, such as documentation layers to add documentation directly within the design file, verification layers to add information related to design verification and/or testing, connectivity information to facilitate routing and signal integrity analysis, such as net labels to identify specific nets or signal paths, pin labels to identify specific pins or connection points, or design rule checks to indicate areas where the design does not comply with specified design rules, such as violation markers indicating specific rule violations, and warning markers indicating potential issues that may need attention. In some cases, watermarking information may also be added.

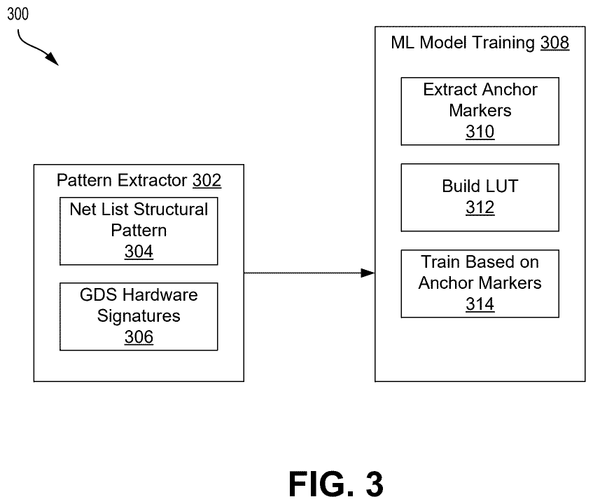

FIG. 3 illustrates a technique for training a machine learning model to recognize hardware signatures 300, in accordance with aspects of the present disclosure. As shown in FIG. 3, a pattern extractor 302 may include the netlist crawler for extracting structural patterns 304 from netlists, as well as the mapper/mapping tool for mapping the structural patterns to the corresponding hardware elements for generating the 2D/3D views for the hardware signatures 306. In some cases, the pattern extractor 302 may be used to extract structural patterns 304 and corresponding hardware signatures 306 across a number of logic circuits of a chip designer. For example, structural patterns 304 and corresponding hardware signatures 306 may be obtained for all reusable circuit blocks in a chip designer's library across multiple different manufacturing processes for multiple foundries to build an ensemble for training.

In some cases, a machine learning (ML) model may be trained 308 based on the structural patterns 304 and corresponding hardware signatures 306. In some cases, the ML model may be neural network, such as a convolutional neural network (CNN) or another network other than a CNN, such as an autoencoder, a deep belief nets (DBNs), a Recurrent Neural Networks (RNNs), among others. The ML model may be trained in set of stages. As an example, in one training stage anchor markers may be extracted 310 from the 2D/3D views from the GDS stored in the database or other memory. In some cases, anchor markers may be elements of the GDS that can aid the ML model to classify and/or identify a signature and/or pattern. The anchor markers may be similar to image feature extractors, for example, in ML models trained to perform computer vision based tasks. In some cases, the anchor markers may look for, for example, relationship/connections between different hardware elements, how certain hardware elements are laid out with respect to other hardware elements, etc. In some cases, the ML model may be trained to recognize hardware elements, hardware signatures, structural patterns, etc. based on the anchor markers. In some cases, the ML model may be trained to determine which anchor models to extract. In some aspects, the ML model may be trained using supervised training based on a labelled dataset using a netlist and GDS anchors. Once training saturation has been reached, the training may be switched to semi-supervised and/or unsupervised.

In another training stage, a set of associated mappings, such as a lookup table (LUT) or other set of associated mappings, may be built 312. In some cases, a LUT may be a table containing different elements and mapping the elements to each other. For example, the LUT may indicate correspondences between certain shapes (e.g., hardware elements in a representation of a logic circuit, such as GDS, images, etc.) in the GDS with certain structural patterns in the netlist, and corresponding structures taking into account the foundry libraries. For example, the foundry libraries may include additional structural components or implement certain structural components in a manner different from tools of the chip designer. In some cases, the foundry libraries may be incorporated into the GDS. In some cases, the LUT may be built as a part of pre-processing data for training.

Another training stage may include training based on the anchor markers 314 and the LUT. For example, one or more portions of the ML model, such feature extractors of the ML model, may be trained, based on the extracted anchor markers, to recognize the anchor markers for a hardware signature in a view of a logic circuit and the ML model may be able to access the LUT so that the ML model may be able to determine how that anchor marker for a hardware signature may appear after the foundry libraries are incorporated (e.g., how the corresponding anchor marker may appear in a GDS from the foundry after applying, for example optical process correction). For example, the ML model may be trained to recognize anchor markers 314 in an image of a logic circuit or a GDS 2D/3D view of a logic circuit. The ML model may also be trained to recognize structural components and/or altered structural components based on the foundry libraries. As another example, the ML model may recognize one or more extracted anchor markers as corresponding to a certain hardware signature in a GDS from the foundry. The ML model may access the LUT to obtain a corresponding set of anchor markers or hardware signature for a GSM from the chip designer. The ML model may look for the corresponding set of anchor markers or hardware signature for the GSM from the chip designer, for example, to verify that hardware signature has not been altered.

Once trained, the ML model may be able to receive a portion of a first GDS, such as a portion of a GDS for the logic circuit being manufactured by a foundry, recognize the structural components and hardware signature(s) present in the portion of the first GDS, receive a corresponding portion of a second GDS from the circuit designer, recognize the structural components and hardware signature(s) and verify whether the portion of the first GDS matches with the portion of the second GDS.

In some cases, the ML model may be trained and the LUT may include information for hardware signatures for the circuit blocks which may be reused for the chip designer, images (e.g., GDS, images captured from de-lidded logic circuits) of logic circuits from other chip designers may be analyzed for hardware signatures of the chip designer. If such hardware signatures from one chip designer being found in logic circuits of another chip designer may be an indication of a potential misappropriation of technology.

In some examples, the LUT may include correspondences between certain shapes (e.g., hardware elements in a representation of a logic circuit, such as GDS, images, etc.) in the GDS with certain structural patterns in the netlist. In such cases, the ML model may be trained to recognize certain hardware elements (e.g., based on anchor points) and generate a netlist based on the recognized hardware elements.

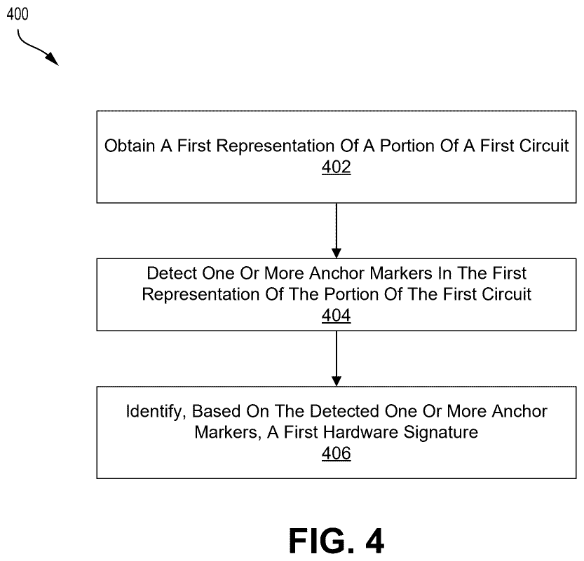

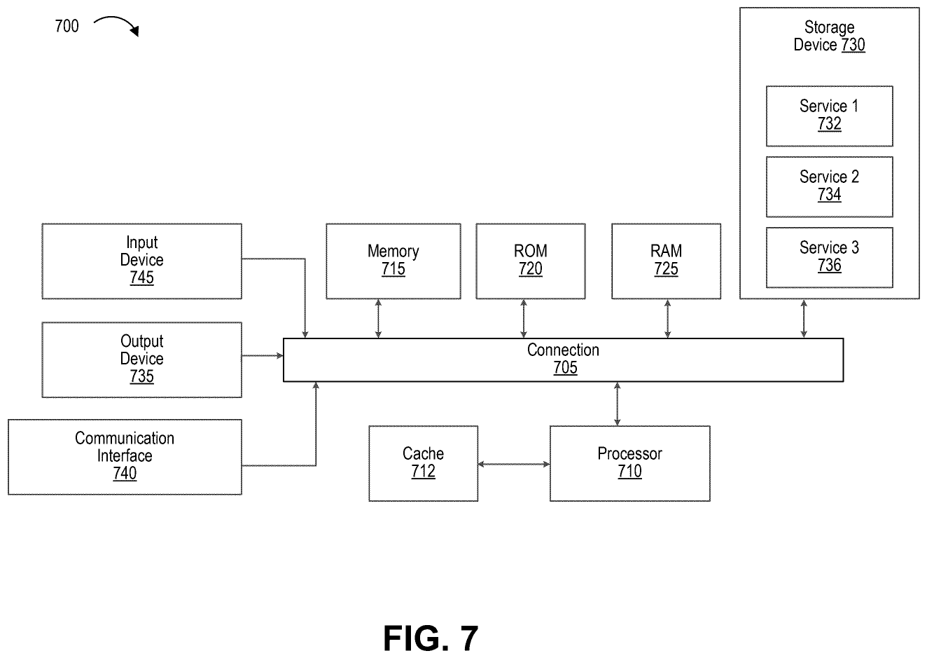

FIG. 4 is a flow diagram illustrating a process 400 for circuit analysis, in accordance with aspects of the present disclosure. The process 400 may be performed by a computing device (or apparatus) or a component (e.g., a chipset, codec, etc.) of the computing device (e.g., computing system 700 of FIG. 7, etc.). The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 400 may be implemented as software components that are executed and run on one or more processors (e.g., processor 710 of FIG. 7, etc.).

At block 402, the computing device (or component thereof) may obtain a first representation (e.g., 2D/3D views 218 of FIG. 2) of a portion of a first circuit. In some cases, the first representation comprises a graphical design system (GDS) view of the first circuit. In some examples, the first representation is received from a third-party foundry. For example, one or more portions of a GDS for the logic circuit being manufactured by a foundry may be received.

At block 404, the computing device (or component thereof) may detect one or more anchor markers in the first representation of the portion of the first circuit. In some cases, anchor markers may be elements of the GDS that can aid the ML model to classify and/or identify a signature and/or pattern.

At block 406, the computing device (or component thereof) may identify, based on the detected one or more anchor markers, a first hardware signature. In some cases, the first hardware signature is identified by a machine learning (ML) model. In some examples, the ML model is a convolutional neural network. In some cases, the ML model is trained based on hardware signatures and netlist structural patterns generated based on a register transfer level (RTL) design of the first circuit. In some examples, the first hardware signature is based on an arrangement of hardware elements of the first circuit for performing a task. In some cases, the computing device (or component thereof) may obtain a second representation of a portion of a second circuit, the second representation including a second hardware signature; and verify the first hardware signature corresponds with the second hardware signature. For example, a portion of a first GDS, such as a portion of a GDS for the logic circuit being manufactured by a foundry, may be received, and the structural components and hardware signature(s) present in the portion of the first GDS may be recognized. A corresponding portion of a second GDS may be received from the circuit designer, structural components and hardware signature(s) may be recognized in the portion of the second GDS, and whether the portion of the first GDS matches with the portion of the second GDS may be verified. In some examples, the computing device (or component thereof) may verify the first hardware signature corresponds with the second hardware signature by accessing a set of associated mappings, wherein the set of associated mappings maps the arrangement of hardware elements of the first hardware signature to an arrangement of hardware elements of the second hardware signature; and verifying the first hardware signature corresponds with the second hardware signature based on the set of associated mappings. In some cases, the computing device (or component thereof) may identify the first hardware signature by: identifying an element to cover based on a register transfer level (RTL) design of the first circuit; identifying a structural pattern corresponding to the element to cover in a netlist based on the RTL design of the first circuit; and corresponding the structural pattern to an arrangement of hardware elements in the first circuit.

As noted herein, the techniques or processes described herein (e.g., the process 400) may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 400 and/or other processes described herein may include a processor, microprocessor, micro-computer, or other component of a device that is configured to carry out the steps of the process 400 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 400 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 400 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 400 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

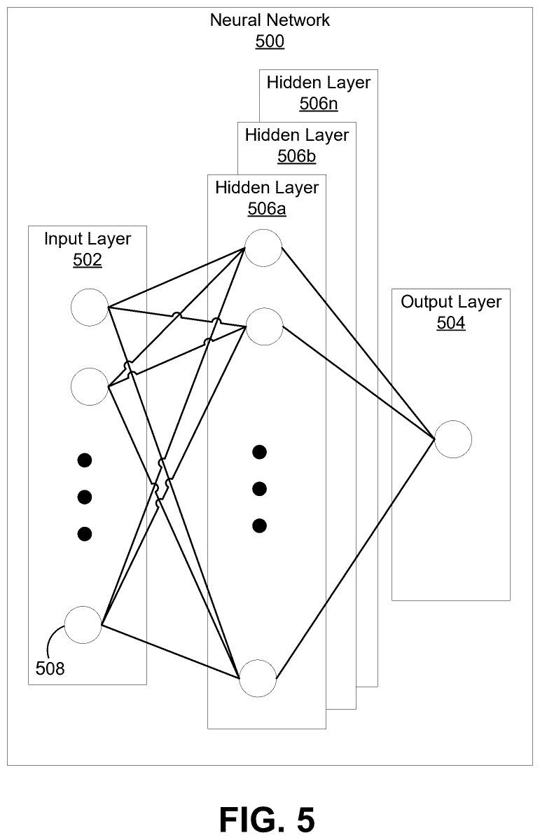

FIG. 5 is an illustrative example of a neural network 500 (e.g., a deep-learning neural network) that can be used to implement machine-learning-based image generation, feature segmentation, implicit-neural-representation generation, rendering, classification, object detection, image recognition (e.g., face recognition, object recognition, scene recognition, etc.), feature extraction, authentication, gaze detection, gaze prediction, and/or automation.

An input layer 502 includes input data. Neural network 500 includes multiple hidden layers hidden layers 506a, 506b, through 506n. The hidden layers 506a, 506b, through hidden layer 506n include “n” number of hidden layers, where “n” is an integer greater than or equal to one. The number of hidden layers can be made to include as many layers as needed for the given application. Neural network 500 further includes an output layer 504 that provides an output resulting from the processing performed by the hidden layers 506a, 506b, through 506n.

Neural network 500 may be, or may include, a multi-layer neural network of interconnected nodes. Each node can represent a piece of information. Information associated with the nodes is shared among the different layers and each layer retains information as information is processed. In some cases, neural network 500 can include a feed-forward network, in which case there are no feedback connections where outputs of the network are fed back into itself. In some cases, neural network 500 can include a recurrent neural network, which can have loops that allow information to be carried across nodes while reading in input.

Information can be exchanged between nodes through node-to-node interconnections between the various layers. Nodes of input layer 502 can activate a set of nodes in the first hidden layer 506a. For example, as shown, each of the input nodes of input layer 502 is connected to each of the nodes of the first hidden layer 506a. The nodes of first hidden layer 506a can transform the information of each input node by applying activation functions to the input node information. The information derived from the transformation can then be passed to and can activate the nodes of the next hidden layer 506b, which can perform their own designated functions. Example functions include convolutional, up-sampling, data transformation, and/or any other suitable functions. The output of the hidden layer 506b can then activate nodes of the next hidden layer, and so on. The output of the last hidden layer 506n can activate one or more nodes of the output layer 504, at which an output is provided. In some cases, while nodes (e.g., node 508) in neural network 500 are shown as having multiple output lines, a node has a single output and all lines shown as being output from a node represent the same output value.

In some cases, each node or interconnection between nodes can have a weight that is a set of parameters derived from the training of neural network 500. Once neural network 500 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 500 to be adaptive to inputs and able to learn as more and more data is processed.

Neural network 500 may be pre-trained to process the features from the data in the input layer 502 using the different hidden layers 506a, 506b, through 506n in order to provide the output through the output layer 504. In an example in which neural network 500 is used to identify features in images, neural network 500 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 500 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until neural network 500 is trained well enough so that the weights of the layers are accurately tuned.

For the example of identifying objects in images, the forward pass can include passing a training image through neural network 500. The weights are initially randomized before neural network 500 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 500, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 500 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as. Eₜₒₜₐₗ=Σ½(target−outout)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 500 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−ηdL/dW, where w denotes a weight, wᵢ denotes the initial weight, and η denotes a learning rate. The learning rate can be set to any suitable value, with a high learning rate including larger weight updates and a lower value indicating smaller weight updates.

Neural network 500 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 500 can include any other deep network other than a CNN, such as an autoencoder, a deep belief nets (DBNs), a Recurrent Neural Networks (RNNs), among others.

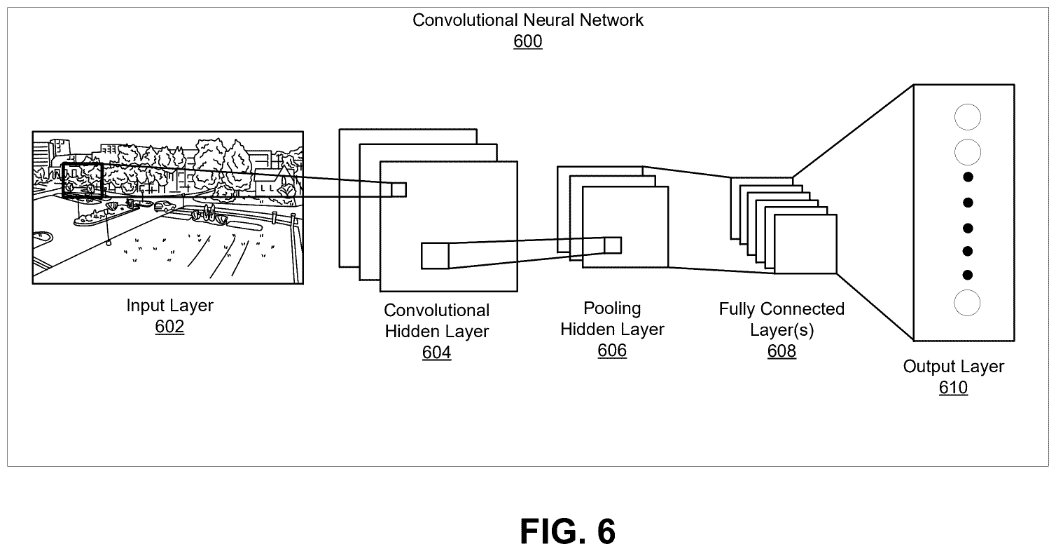

FIG. 6 is an illustrative example of a convolutional neural network (CNN) 600. The input layer 602 of the CNN 600 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 604, an optional non-linear activation layer, a pooling hidden layer 606, and fully connected layer 608 (which fully connected layer 608 can be hidden) to get an output at the output layer 610. While only one of each hidden layer is shown in FIG. 6, one of ordinary skill will appreciate that multiple convolutional hidden layers, non-linear layers, pooling hidden layers, and/or fully connected layers can be included in the CNN 600. As previously described, the output can indicate a single class of an object or can include a probability of classes that best describe the object in the image.

The first layer of the CNN 600 can be the convolutional hidden layer 604. The convolutional hidden layer 604 can analyze image data of the input layer 602. Each node of the convolutional hidden layer 604 is connected to a region of nodes (pixels) of the input image called a receptive field. The convolutional hidden layer 604 can be considered as one or more filters (each filter corresponding to a different activation or feature map), with each convolutional iteration of a filter being a node or neuron of the convolutional hidden layer 604. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 604. Each connection between a node and a receptive field for that node learns a weight and, in some cases, an overall bias such that each node learns to analyze its particular local receptive field in the input image. Each node of the convolutional hidden layer 604 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 604 is due to each node of the convolutional layer being applied to its corresponding receptive field. For example, a filter of the convolutional hidden layer 604 can begin in the top-left corner of the input image array and can convolve around the input image. As noted above, each convolutional iteration of the filter can be considered a node or neuron of the convolutional hidden layer 604. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 604. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 604.

The mapping from the input layer to the convolutional hidden layer 604 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 604 can include several activation maps in order to identify multiple features in an image. The example shown in FIG. 6 includes three activation maps. Using three activation maps, the convolutional hidden layer 604 can detect three different kinds of features, with each feature being detectable across the entire image.

In some examples, a non-linear hidden layer can be applied after the convolutional hidden layer 604. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 600 without affecting the receptive fields of the convolutional hidden layer 604.

The pooling hidden layer 606 can be applied after the convolutional hidden layer 604 (and after the non-linear hidden layer when used). The pooling hidden layer 606 is used to simplify the information in the output from the convolutional hidden layer 604. For example, the pooling hidden layer 606 can take each activation map output from the convolutional hidden layer 604 and generates a condensed activation map (or feature map) using a pooling function. Max-pooling is one example of a function performed by a pooling hidden layer. Other forms of pooling functions be used by the pooling hidden layer 606, such as average pooling, L2-norm pooling, or other suitable pooling functions. A pooling function (e.g., a max-pooling filter, an L2-norm filter, or other suitable pooling filter) is applied to each activation map included in the convolutional hidden layer 604. In the example shown in FIG. 6, three pooling filters are used for the three activation maps in the convolutional hidden layer 604.

In some examples, max-pooling can be used by applying a max-pooling filter (e.g., having a size of 2×2) with a stride (e.g., equal to a dimension of the filter, such as a stride of 2) to an activation map output from the convolutional hidden layer 604. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 604 having a dimension of 24×24 nodes, the output from the pooling hidden layer 606 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 600.

The final layer of connections in the network is a fully-connected layer that connects every node from the pooling hidden layer 606 to every one of the output nodes in the output layer 610. Using the example above, the input layer includes 28×28 nodes encoding the pixel intensities of the input image, the convolutional hidden layer 604 includes 3×24×24 hidden feature nodes based on application of a 5×5 local receptive field (for the filters) to three activation maps, and the pooling hidden layer 606 includes a layer of 3×12×12 hidden feature nodes based on application of max-pooling filter to 2×2 regions across each of the three feature maps. Extending this example, the output layer 610 can include ten output nodes. In such an example, every node of the 3×12×12 pooling hidden layer 606 is connected to every node of the output layer 610.

The fully connected layer 608 can obtain the output of the previous pooling hidden layer 606 (which should represent the activation maps of high-level features) and determines the features that most correlate to a particular class. For example, the fully connected layer 608 can determine the high-level features that most strongly correlate to a particular class and can include weights (nodes) for the high-level features. A product can be computed between the weights of the fully connected layer 608 and the pooling hidden layer 606 to obtain probabilities for the different classes. For example, if the CNN 600 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 610 can include an M-dimensional vector (in the prior example, M=10). M indicates the number of classes that the CNN 600 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

In some aspects, training of one or more of the machine learning systems or neural networks described herein (e.g., such as the technique for training a machine learning model to recognize hardware signatures 300 of FIG. 3, among various other machine learning systems or neural networks described herein) can be performed using online training (e.g., in some case on-device training), offline training, and/or various combinations of online and offline training. In some cases, online may refer to time periods during which the input data is processed, for instance for performance of the speech restoration processing implemented by the systems and techniques described herein. In some examples, offline may refer to idle time periods or time periods during which input data is not being processed. Additionally, offline may be based on one or more time conditions (e.g., after a particular amount of time has expired, such as a day, a week, a month, etc.) and/or may be based on various other conditions such as network and/or server availability, etc., among various others. In some aspects, offline training of a machine learning model (e.g., a neural network model) can be performed by a first device (e.g., a server device) to generate a pre-trained model, and a second device can receive the trained model from the second device. In some cases, the second device (e.g., a mobile device, an XR device, a vehicle or system/component of the vehicle, or other device) can perform online (or on-device) training of the pre-trained model to further adapt or tune the parameters of the model.

FIG. 7 is a diagram illustrating an example of a system for implementing certain aspects of the present technology. In particular, FIG. 7 illustrates an example of computing system 700, which can be for example any computing device making up internal computing system, a remote computing system, a camera, or any component thereof in which the components of the system are in communication with each other using connection 705. Connection 705 can be a physical connection using a bus, or a direct connection into processor 710, such as in a chipset architecture. Connection 705 can also be a virtual connection, networked connection, or logical connection.

In some examples, computing system 700 is a distributed system in which the functions described in this disclosure can be distributed within a datacenter, multiple data centers, a peer network, etc. In some examples, one or more of the described system components represents many such components each performing some or all of the functions for which the component is described. In some cases, the components can be physical or virtual devices.

Example system 700 includes at least one processing unit (CPU or processor) 710 and connection 705 that couples various system components including system memory 715, such as read-only memory (ROM) 720 and random access memory (RAM) 725 to processor 710. Computing system 700 can include a cache 712 of high-speed memory connected directly with, in close proximity to, or integrated as part of processor 710.

Processor 710 can include any general purpose processor and a hardware service or software service, such as services 732, 734, and 736 stored in storage device 730, configured to control processor 710 as well as a special-purpose processor where software instructions are incorporated into the actual processor design. Processor 710 may be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, camera, accelerometers, gyroscopes, etc. Computing system 700 can also include output device 735, which can be one or more of a number of output mechanisms. In some instances, multimodal systems can enable a user to provide multiple types of input/output to communicate with computing system 700. Computing system 700 can include communications interface 740, which can generally govern and manage the user input and system output. The communication interface may perform or facilitate receipt and/or transmission of wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 730 can include software services, servers, services, etc., that when the code that defines such software is executed by the processor 710, it causes the system to perform a function. In some examples, a hardware service that performs a particular function can include the software component stored in a computer-readable medium in connection with the necessary hardware components, such as processor 710, connection 705, output device 735, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some examples, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the examples provided herein. However, it will be understood by one of ordinary skill in the art that the examples may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the examples in unnecessary detail. In other instances, well-known circuits, processes, algorithms, structures, and techniques may be shown without unnecessary detail in order to avoid obscuring the examples.

Individual examples may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples thereof, but those skilled in the art will recognize that the application is not limited thereto. Thus, while illustrative examples of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, examples can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the present disclosure include:

Aspect 1. An apparatus for circuit analysis, comprising: memory system comprising instructions; and a processor system coupled to the memory system, wherein the processor system is configured to: obtain a first representation of a portion of a first circuit; detect one or more anchor markers in the first representation of the portion of the first circuit; and identify, based on the detected one or more anchor markers, a first hardware signature, wherein the first hardware signature is based on an arrangement of hardware elements of the first circuit for performing a task.

Aspect 2. The apparatus of Aspect 1, wherein the processor system is further configured to: obtain a second representation of a portion of a second circuit, the second representation including a second hardware signature; and verify the first hardware signature corresponds with the second hardware signature.

Aspect 3. The apparatus of Aspect 2, wherein, to verify the first hardware signature corresponds with the second hardware signature, the processor system is further configured to: access a set of associated mappings, wherein the set of associated mappings maps the arrangement of hardware elements of the first hardware signature to an arrangement of hardware elements of the second hardware signature; and verify the first hardware signature corresponds with the second hardware signature based on the set of associated mappings.

Aspect 4. The apparatus of any of Aspects 1-3, wherein the first representation comprises a graphical design system (GDS) view of the first circuit.

Aspect 5. The apparatus of any of Aspects 1-4, wherein the first hardware signature is identified by a machine learning (ML) model.

Aspect 6. The apparatus of Aspect 5, wherein the ML model is a convolutional neural network.

Aspect 7. The apparatus of any of Aspects 5-6, wherein the ML model is trained based on hardware signatures and netlist structural patterns generated based on a register transfer level (RTL) design of the first circuit.

Aspect 8. The apparatus of any of Aspects 1-7, wherein, to identify the first hardware signature, the processor system is further configured to: identify an element to cover based on a register transfer level (RTL) design of the first circuit; identify a structural pattern corresponding to the element to cover in a netlist based on the RTL design of the first circuit; and correspond the structural pattern to an arrangement of hardware elements in the first circuit.

Aspect 9. The apparatus of any of Aspects 1-8, wherein the first representation is received from a third-party foundry.

Aspect 10. A method for circuit analysis, comprising: obtaining a first representation of a portion of a first circuit; detecting one or more anchor markers in the first representation of the portion of the first circuit; and identifying, based on the detected one or more anchor markers, a first hardware signature, wherein the first hardware signature is based on an arrangement of hardware elements of the first circuit for performing a task.

Aspect 11. The method of Aspect 10, further comprising: obtaining second representation of a portion of a second circuit, the second representation including a second hardware signature; and verifying the first hardware signature corresponds with the second hardware signature.

Aspect 12. The method of Aspect 11, wherein verifying the first hardware signature corresponds with the second hardware signature comprises: accessing a set of associated mappings, wherein the set of associated mappings maps the arrangement of hardware elements of the first hardware signature to an arrangement of hardware elements of the second hardware signature; and verifying the first hardware signature corresponds with the second hardware signature based on the set of associated mappings.

Aspect 13. The method of any of Aspects 10-12, wherein the first representation comprises a graphical design system (GDS) view of the first circuit.

Aspect 14. The method of any of Aspects 10-13, wherein the first hardware signature is identified by a machine learning (ML) model.

Aspect 15. The method of Aspect 14, wherein the ML model is a convolutional neural network.

Aspect 16. The method of any of Aspects 14-15, wherein the ML model is trained based on hardware signatures and netlist structural patterns generated based on a register transfer level (RTL) design of the first circuit.

Aspect 17. The method of any of Aspects 10-16, wherein the first hardware signature was identified by: identifying an element to cover based on a register transfer level (RTL) design of the first circuit; identifying a structural pattern corresponding to the element to cover in a netlist based on the RTL design of the first circuit; and corresponding the structural pattern to an arrangement of hardware elements in the first circuit.

Aspect 18. The method of any of Aspects 10-17, wherein the first representation is received from a third-party foundry.

Aspect 19. A non-transitory computer-readable medium having stored thereon instructions that, when executed by a processor system, cause the processor system to: obtain a first representation of a portion of a first circuit; detect one or more anchor markers in the first representation of the portion of the first circuit; and identify, based on the detected one or more anchor markers, a first hardware signature, wherein the first hardware signature is based on an arrangement of hardware elements of the first circuit for performing a task.

Aspect 20. The non-transitory computer-readable medium of Aspect 19, wherein the instructions further cause the processor system to: obtain a second representation of a portion of a second circuit, the second representation including a second hardware signature; and verify the first hardware signature corresponds with the second hardware signature.

Aspect 21. A non-transitory computer-readable medium having stored thereon instructions that, when executed by a processor system, cause the processor system to perform one or more of operations according to any of Aspects 10-18.

Aspect 22. An apparatus for circuit analysis, comprising means for performing one or more of operations according to any of Aspects 10-18.

What is claimed is:

1. An apparatus for circuit analysis, comprising:
memory system comprising instructions; and
a processor system coupled to the memory system, wherein the processor system is configured to:
obtain a first representation of a portion of a first circuit;
detect an anchor marker in the first representation of the portion of the first circuit; and
identify, based on the detected one or more anchor markers, a first hardware signature, wherein the first hardware signature is based on an arrangement of hardware elements of the first circuit for performing a task.

2. The apparatus of claim 1, wherein the processor system is further configured to:
obtain a second representation of a portion of a second circuit, the second representation including a second hardware signature; and
verify the first hardware signature corresponds with the second hardware signature.

3. The apparatus of claim 2, wherein, to verify the first hardware signature corresponds with the second hardware signature, the processor system is further configured to:
access a set of associated mappings, wherein the set of associated mappings maps the arrangement of hardware elements of the first hardware signature to an arrangement of hardware elements of the second hardware signature; and
verify the first hardware signature corresponds with the second hardware signature based on the set of associated mappings.

4. The apparatus of claim 1, wherein the first representation comprises a graphical design system (GDS) view of the first circuit.

5. The apparatus of claim 1, wherein the first hardware signature is identified by a machine learning (ML) model.

6. The apparatus of claim 5, wherein the ML model is a convolutional neural network.

7. The apparatus of claim 5, wherein the ML model is trained based on hardware signatures and netlist structural patterns generated based on a register transfer level (RTL) design of the first circuit.

8. The apparatus of claim 1, wherein, to identify the first hardware signature, the processor system is further configured to:
identify an element to cover based on a register transfer level (RTL) design of the first circuit;
identify a structural pattern corresponding to the element to cover in a netlist based on the RTL design of the first circuit; and
correspond the structural pattern to an arrangement of hardware elements in the first circuit.

9. The apparatus of claim 1, wherein the first representation is received from a third-party foundry.

10. A method for circuit analysis, comprising:
obtaining a first representation of a portion of a first circuit;
detecting one or more anchor markers in the first representation of the portion of the first circuit; and
identifying, based on the detected one or more anchor markers, a first hardware signature, wherein the first hardware signature is based on an arrangement of hardware elements of the first circuit for performing a task.

11. The method of claim 10, further comprising:
obtaining second representation of a portion of a second circuit, the second representation including a second hardware signature; and
verifying the first hardware signature corresponds with the second hardware signature.

12. The method of claim 11, wherein verifying the first hardware signature corresponds with the second hardware signature comprises:
accessing a set of associated mappings, wherein the set of associated mappings maps the arrangement of hardware elements of the first hardware signature to an arrangement of hardware elements of the second hardware signature; and
verifying the first hardware signature corresponds with the second hardware signature based on the set of associated mappings.

13. The method of claim 10, wherein the first representation comprises a graphical design system (GDS) view of the first circuit.

14. The method of claim 10, wherein the first hardware signature is identified by a machine learning (ML) model.

15. The method of claim 14, wherein the ML model is a convolutional neural network.

16. The method of claim 14, wherein the ML model is trained based on hardware signatures and netlist structural patterns generated based on a register transfer level (RTL) design of the first circuit.

17. The method of claim 10, wherein the first hardware signature was identified by:
identifying an element to cover based on a register transfer level (RTL) design of the first circuit;
identifying a structural pattern corresponding to the element to cover in a netlist based on the RTL design of the first circuit; and
corresponding the structural pattern to an arrangement of hardware elements in the first circuit.

18. The method of claim 10, wherein the first representation is received from a third-party foundry.

19. A non-transitory computer-readable medium having stored thereon instructions that, when executed by a processor system, cause the processor system to:
obtain a first representation of a portion of a first circuit;
detect one or more anchor markers in the first representation of the portion of the first circuit; and
identify, based on the detected one or more anchor markers, a first hardware signature, wherein the first hardware signature is based on an arrangement of hardware elements of the first circuit for performing a task.

20. The non-transitory computer-readable medium of claim 19, wherein the instructions further cause the processor system to:
obtain a second representation of a portion of a second circuit, the second representation including a second hardware signature; and
verify the first hardware signature corresponds with the second hardware signature.
